(19) United States
(12) Patent Application Publication
(10) Pub. No.: US 2006/0076908 A1
(43) Pub. Date: Apr. 13, 2006

(54) Lighting zone control methods and apparatus

(75) Inventors: Frederick M. Morgan, Quincy, MA (US); Brian Chemel, Marblehead, MA (US); Colin Piepgras, Swampscott, MA (US); Tomas Mollnow, Somerville, MA (US); Michael K. Blackwell, Milton, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Color Kinetics Incorporated, Boston, MA (US)

(21) Appl. No.: 11/224,683

(22) Filed: Sep. 12, 2005

Related U.S. Application Data
(60) Provisional application No. 60/608,847, filed on Sep. 10, 2004.

(51) Int. Cl. H05B 39/00

(52) U.S. Cl. 315/312

(57) ABSTRACT

Lighting networks that include multiple LED-based lighting units, and user interfaces to facilitate control of such networks. Lighting units of a lighting network may be configured to generate one or more of variable color light, variable intensity light, and variable color temperature white light. Different areas of an environment in which light is provided by the lighting network may be divided into respective lighting zones, and some or all of the lighting units of the lighting network may be configured so as to provide controllable lighting in one or more such lighting zones. One or more user interfaces are configured so as to allow relatively simplified and intuitive control of the lighting network, either manually (in real time) or via one or more user-selectable predetermined lighting programs.

### CROSS-REFERENCES TO RELATED APPLICATIONS

This present application claims the benefit, under 35 U.S.C. 119(e), of U.S. Provisional Application Ser. No. 60/608,847, filed Sep. 10, 2004, entitled “Lighting Zone Controller Methods and Systems,” which application is hereby incorporated by reference.

### BACKGROUND

Various conventional lighting systems offer users some degree of control over lighting in a given environment. For example, a lighting system in a home, work or retail environment may be equipped with one or more user interfaces or controls that allow for turning one or more lighting units on and off, and/or dimming one or more lighting units. In some specialized environments such as concert or theatre lighting, for example, sophisticated lighting controllers requiring significant expertise may be employed to control complex lighting systems including many individual lighting units, and a wide variety of different types of lighting units.

Presently, more advanced types of lighting units that are capable of a significant degree of control over generated light are becoming increasingly available for every day environments. For example, LED-based lighting units are conventionally available, in which the color and/or intensity of generated light may be varied. In addition to generating a wide variety of different colors, such lighting units also may be configured to generate substantially white light that may be varied in intensity as well as “color temperature” or shade of white (e.g., warm white to cool white).

Multiple LED-based lighting units may be deployed in a wide variety of configurations to form a lighting system in a given environment. In various examples of such lighting systems, one or more lighting units of the system may be controlled via a “local” user interface, such as a standard light switch or dimmer control. Additionally, groups of lighting units, or the entire configuration of lighting units that form the lighting system, may be coupled together and controlled collectively, in some cases in an automated and/or coordinated fashion, via one or more controllers. In some implementations, the lighting system may be formed as a lighting network in which communication of control signals or control data to one or more lighting units occurs over wired or wireless communication links. In such a lighting network, one or more network controllers may be configured to provide control signals to the lighting units based on the execution of one or more predetermined lighting programs.

### SUMMARY

As discussed above, lighting systems employing a number of LED-based lighting units may be configured as controllable lighting networks. Such lighting networks may be deployed in a variety of environments and in a variety of potentially complex configurations, providing a number of sophisticated lighting possibilities. In view of the foregoing, various embodiments of the present disclosure relates to a user interface configured to facilitate control of various aspects of such a lighting network in a relatively simplified and intuitive fashion.

An apparatus according to one embodiment of the present disclosure comprises at least one user interface to facilitate control of a lighting network including multiple LED-based lighting units configured to provide light in a plurality of lighting zones. At least a first light is provided in a first zone of the plurality of lighting zones, wherein the first light is perceived as essentially white light. The user interface comprises at least one first mechanism to facilitate a selection of a first color temperature of the first light generated in the first lighting zone.

Another embodiment is directe to a method of controlling a lighting network including multiple LED-based lighting units configured to provide light in a plurality of lighting zones, wherein at least a first light is provided in a first zone of the plurality of lighting zones, the first light being perceived as essentially white light. The method comprises selecting a first color temperature of the first light.

Another embodiment is directed to a lighting network, comprising a plurality of LED-based lighting units configured to provide light in a plurality of lighting zones, wherein at least a first light is provided in a first zone of the plurality of lighting zones, the first light being perceived as essentially white light, and wherein a second light is provided in a second zone of the plurality of lighting zones, the first light being perceived as essentially white light. The network further comprises at least one user interface configured to facilitate a selection or adjustment of a first color temperature of the first light and a second color temperature of the second light.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured to generate radiation having various bandwidths for a given spectrum (e.g., narrow bandwidth, broad bandwidth).

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication and/or illumination. An “illumination source” is a light source that is particularly configured to generate radiation having a sufficient intensity to effectively illuminate an interior or exterior space.

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. The color temperature of white light generally falls within a range of from approximately 700 degrees K (generally considered the first visible to the human eye) to over 10,000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The terms “lighting unit” and “lighting fixture” are used interchangeably herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

The terms “processor” or “controller” are used herein interchangeably to describe various apparatus relating to the operation of one or more light sources. A processor or controller can be implemented in numerous ways, such as with dedicated hardware, using one or more microprocessors that are programmed using software (e.g., microcode) to perform the various functions discussed herein, or as a combination of dedicated hardware to perform some functions and programmed microprocessors and associated circuitry to perform other functions. Examples of processor or controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication-protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, touchpads, microphones and other types of sensors that may receive some form of human-generated stimulus and generate a signal in response thereto.

The following patents and patent applications are hereby incorporated herein by reference:

U.S. Pat. No. 6,016,038, issued Jan. 18, 2000, entitled “Multicolored LED Lighting Method and Apparatus;”

U.S. Pat. No. 6,211,626, issued Apr. 3, 2001 to Lys et al, entitled “Illumination Components;”

U.S. Pat. No. 6,608,453, issued Aug. 19, 2003, entitled “Methods and Apparatus for Controlling Devices in a Networked Lighting System;”

U.S. Pat. No. 6,548,967, issued Apr. 15, 2003, entitled “Universal Lighting Network Methods and Systems;”

U.S. patent application Ser. No. 09/886,958, filed Jun. 21, 2001, entitled Method and Apparatus for Controlling a Lighting System in Response to an Audio Input;”

U.S. patent application Ser. No. 10/078,221, filed Feb. 19, 2002, entitled “Systems and Methods for Programming Illumination Devices;”

U.S. patent application Ser. No. 09/344,699, filed Jun. 25, 1999, entitled “Method for Software Driven Generation of Multiple Simultaneous High Speed Pulse Width Modulated Signals;”

U.S. patent application Ser. No. 09/805,368, filed Mar. 13, 2001, entitled “Light-Emitting Diode Based Products;”

U.S. patent application Ser. No. 09/716,819, filed Nov. 20, 2000, entitled “Systems and Methods for Generating and Modulating Illumination Conditions;”

U.S. patent application Ser. No. 09/675,419, filed Sep. 29, 2000, entitled “Systems and Methods for Calibrating Light Output by Light-Emitting Diodes;”

U.S. patent application Ser. No. 09/870,418, filed May 30, 2001, entitled “A Method and Apparatus for Authoring and Playing Back Lighting Sequences;”

U.S. patent application Ser. No. 10/045,604, filed Mar. 27, 2003, entitled “Systems and Methods for Digital Entertainment;”

U.S. patent application Ser. No. 10/045,629, filed Oct. 25, 2001, entitled “Methods and Apparatus for Controlling Illumination;”

U.S. patent application Ser. No. 09/989,677, filed Nov. 20, 2001, entitled “Information Systems;”

U.S. patent application Ser. No. 10/158,579, filed May 30, 2002, entitled “Methods and Apparatus for Controlling Devices in a Networked Lighting System;”

U.S. patent application Ser. No. 10/163,085, filed Jun. 5, 2002, entitled “Systems and Methods for Controlling Programmable Lighting Systems;”

U.S. patent application Ser. No. 10/174,499, filed Jun. 17, 2002, entitled “Systems and Methods for Controlling Illumination Sources;”

U.S. patent application Ser. No. 10/245,788, filed Sep. 17, 2002, entitled “Methods and Apparatus for Generating and Modulating White Light Illumination Conditions;”

U.S. patent application Ser. No. 10/245,786, filed Sep. 17, 2002, entitled “Light Emitting Diode Based Products;”

U.S. patent application Ser. No. 10/325,635, filed Dec. 19, 2002, entitled “Controlled Lighting Methods and Apparatus;”

U.S. patent application Ser. No. 10/360,594, filed Feb. 6, 2003, entitled “Controlled Lighting Methods and Apparatus;”

U.S. patent application Ser. No. 10/435,687, filed May 9, 2003, entitled “Methods and Apparatus for Providing Power to Lighting Devices;”

U.S. patent application Ser. No. 10/828,933, filed Apr. 21, 2004, entitled “Tile Lighting Methods and Systems;”

U.S. patent application Ser. No. 10/839,765, filed May 5, 2004, entitled “Lighting Methods and Systems;”

U.S. patent application Ser. No. 11/010,840, filed Dec. 13, 2004, entitled “Thermal Management Methods and Apparatus for Lighting Devices;”

U.S. patent application Ser. No. 11/079,904, filed Mar. 14, 2005, entitled “LED Power Control Methods and Apparatus;” and

U.S. patent application Ser. No. 11/081,020, filed on Mar. 15, 2005, entitled “Methods and Systems for Providing Lighting Systems.”

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

FIG. 1 is a diagram illustrating a lighting unit according to one embodiment of the disclosure.

FIG. 2 is a diagram illustrating a networked lighting system according to one embodiment of the disclosure.

FIGS. 3 through 6 illustrate examples of user interfaces according to various embodiment of the present disclosure.

FIG. 7 illustrates a complex configuration of a lighting network similar to the network shown in FIG. 2, according to one embodiment of the present disclosure.

FIGS. 8-10 are diagrams of a retail environment, an office environment, and a home environment, respectively, in which a multiple-zone lighting network according to various embodiments of the present disclosure is employed.

FIG. 11 is a diagram similar to FIG. 7, showing another multiple-zone configuration of a lighting network, according to one embodiment of the present disclosure.

FIG. 12 shows yet another somewhat complex lighting network configuration employing multiple user interfaces, similar to those discussed above in connection with FIGS. 3-6, according to another embodiment of the present disclosure.

FIGS. 13 and 14 show a large building environment and a large retail environment, respectively, in which a lighting network similar to that shown in FIG. 12 may be deployed.

### DETAILED DESCRIPTION

Various embodiments of the present disclosure are described below, including certain embodiments relating particularly to LED-based light sources. It should be appreciated, however, that the present disclosure is not limited to any particular manner of implementation, and that the various embodiments discussed explicitly herein are primarily for purposes of illustration. For example, the various concepts discussed herein may be suitably implemented in a variety of environments involving LED-based light sources, other types of light sources not including LEDs, environments that involve both LEDs and other types of light sources in combination, and environments that involve non-lighting-related devices alone or in combination with various types of light sources.

The present disclosure relates generally to user interfaces configured to facilitate control of a lighting network that includes multiple LED-based lighting units. In one aspect, lighting units of such a lighting network may be configured to generate one or more of variable color light, variable intensity light, and variable color temperature white light. In another aspect of such a lighting network, different areas of an environment in which light is provided by the lighting network may be divided into respective lighting zones, and some or all of the lighting units of the lighting network may be configured so as to provide controllable lighting in one or more such lighting zones. In various embodiments disclosed herein, one or more user interfaces are configured so as to allow relatively simplified and intuitive control of the lighting network, either manually (in real time) or via user-selectable predetermined lighting programs, to provide variable color light, variable intensity light, variable color temperature white light, or some preset fixed light condition in one or more such lighting zones.

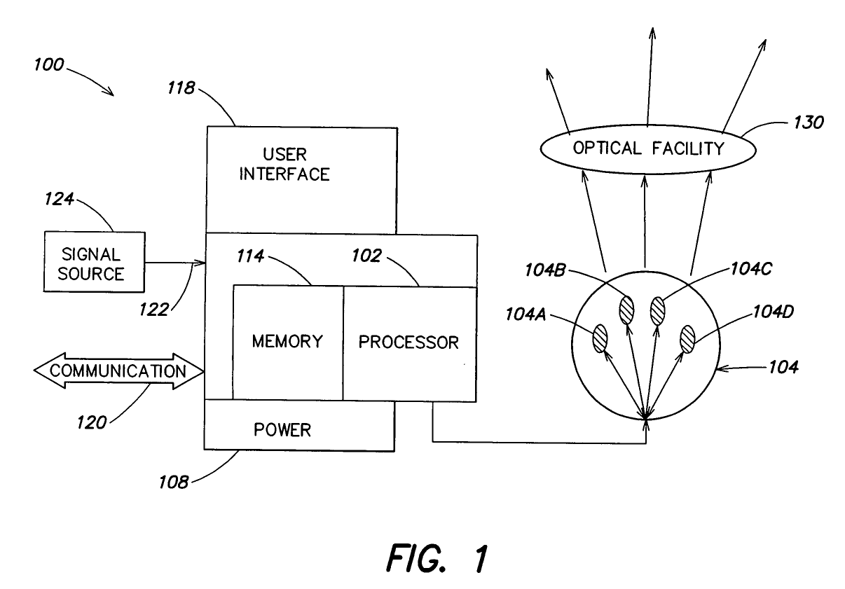

FIG. 1 illustrates one example of a lighting unit 100 that may serve as a device in a lighting network configured to provide lighting in multiple lighting zones, according to one embodiment of the present disclosure. Some examples of LED-based lighting units similar to those that are described below in connection with FIG. 1 may be found, for example, in U.S. Pat. No. 6,016,038, issued Jan. 18, 2000 to Mueller et al., entitled “Multicolored LED Lighting Method and Apparatus,” and U.S. Pat. No. 6,211,626, issued Apr. 3, 2001 to Lys et al, entitled “Illumination Components,” which patents are both hereby incorporated herein by reference.

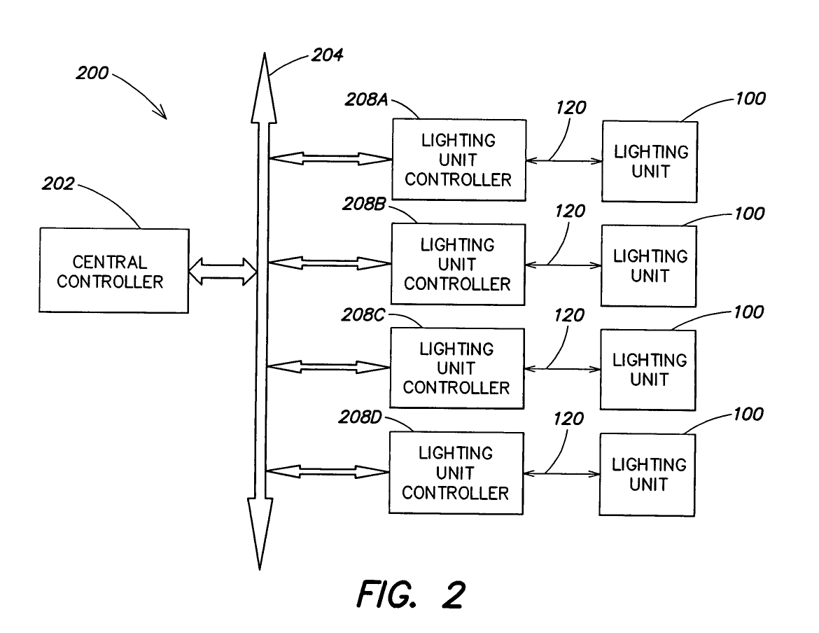

In various embodiments of the present disclosure, the lighting unit 100 shown in FIG. 1 may be used together with other similar lighting units or different lighting units to form a lighting system or lighting network (e.g., as discussed further below in connection with FIG. 2). Used alone or in combination with other lighting units, the lighting unit 100 may be employed in a variety of applications including, but not limited to, interior or exterior space illumination in general, direct or indirect illumination of objects or spaces, theatrical or other entertainment-based/special effects lighting, decorative lighting, safety-oriented lighting, vehicular lighting, illumination of displays and/or merchandise (e.g. for advertising and/or in retail/consumer environments), combined illumination and communication systems, etc., as well as for various indication and informational purposes.

Additionally, one or more lighting units similar to that described in connection with FIG. 1 may be implemented, in whole or in part, in a variety of products including, but not limited to, various forms of light modules or bulbs having various shapes and electrical/mechanical coupling arrangements (including replacement or “retrofit” modules or bulbs adapted for use in conventional sockets or fixtures). In this manner, various embodiments of a lighting network according to the present disclosure may be constituted, in whole or in part, of lighting units having any one of a number of possible form factors, including lighting units configured with conventional form factors (e.g., resembling incandescent, fluorescent or halogen bulbs) and adapted for use in conventional sockets of fixtures.

In one embodiment, the lighting unit 100 shown in FIG. 1 may include one or more light sources 104A, 104B, and 104C (shown collectively as 104), wherein one or more of the light sources may be an LED-based light source that includes one or more light emitting diodes (LEDs). In one aspect of this embodiment, any two or more of the light sources 104A, 104B, and 104C may be adapted to generate radiation of different colors (e.g. red, green, and blue, respectively). Although FIG. 1 shows three light sources 104A, 104B, and 104C, it should be appreciated that the lighting unit is not limited in this respect, as different numbers and various types of light sources (all LED-based light sources, LED-based and non-LED-based light sources in combination, etc.) adapted to generate radiation of a variety of different colors, including essentially white light, may be employed in the lighting unit 100, as discussed further below.

As shown in FIG. 1, the lighting unit 100 also may include a processor 102 that is configured to output one or more control signals to drive the light sources 104A, 104B, and 104C so as to generate various intensities of light from the light sources. For example, in one implementation, the processor 102 may be configured to output one or more control signals so as to control the respective intensities of radiation having different spectrums generated by the light sources. Some examples of control signals that may be generated by the processor to control the light sources include, but are not limited to, pulse modulated signals, pulse width modulated signals (PWM), pulse amplitude modulated signals (PAM), pulse code modulated signals (PCM) analog control signals (e.g., current control signals, voltage control signals), combinations and/or modulations of the foregoing signals, or other control signals. In one aspect, the processor 102 may control other dedicated circuitry (not shown in FIG. 1) which in turn controls the light sources so as to vary respective intensities of radiation having different spectrums generated by the light sources.

In one embodiment of the lighting unit 100, one or more of the light sources 104A, 104B, and 104C shown in FIG. 1 may include a group of multiple LEDs or other types of light sources (e.g., various parallel and/or serial connections of LEDs or other types of light sources) that are controlled together by the processor 102. Additionally, it should be appreciated that one or more of the light sources 104A, 104B, and 104C may include one or more LEDs that are adapted to generate radiation having any of a variety of spectrums (i.e., wavelengths or wavelength bands), including, but not limited to, various visible colors (including essentially white light), various color temperatures of white light, ultraviolet, or infrared. LEDs having a variety of spectral bandwidths (e.g., narrow band, broader band) may be employed in various implementations of the lighting unit 100.

In another aspect of the lighting unit 100 shown in FIG. 1, the lighting unit 100 may be constructed and arranged to produce a wide range of variable color radiation. For example, the lighting unit 100 may be particularly arranged such that the processor-controlled variable intensity light generated by two or more of the light sources combines to produce a mixed colored light (including essentially white light having a variety of color temperatures). In particular, the color (or color temperature) of the mixed colored light may be varied by varying one or more of the respective intensities of the light sources (e.g., in response to one or more control signals output by the processor 102). Furthermore, the processor 102 may be particularly configured (e.g., programmed) to provide control signals to one or more of the light sources so as to generate a variety of static or time-varying (dynamic) multi-color (or multi-color temperature) lighting effects.

Thus, the lighting unit 100 may include a wide variety of colors of LEDs in various combinations, including relatively narrow bandwidth or relatively broad bandwidth (phosphor-coated) LEDs, to create multiple colors of light and multiple color temperatures of white light based on color mixing principles. Such combinations of differently colored LEDs in the lighting unit 100 can facilitate accurate reproduction of a host of desirable spectrums of lighting conditions, examples of which includes, but are not limited to, a variety of outside daylight equivalents at different times of the day, various interior lighting conditions, lighting conditions to simulate a complex multicolored background, lighting conditions replicating conventional incandescent, fluorescent or halogen lighting, and the like. Other desirable lighting conditions can be created by removing particular pieces of spectrum that may be specifically absorbed, attenuated or reflected in certain environments. Water, for example tends to absorb and attenuate most non-blue and non-green colors of light, so underwater applications may benefit from lighting conditions that are tailored to emphasize or attenuate some spectral elements relative to others.

As shown in FIG. 1, the lighting unit 100 also may include a memory 114 to store various information. For example, the memory 114 may be employed to store one or more lighting programs for execution by the processor 102 (e.g., to generate one or more control signals for the light sources), as well as various types of data useful for generating variable color radiation (e.g., calibration information, discussed further below). The memory 114 also may store one or more particular identifiers (e.g., a serial number, an address, etc.) that may be used either locally or on a system level to identify the lighting unit 100. In various embodiments, such identifiers may be pre-programmed by a manufacturer, for example, and may be either alterable or non-alterable thereafter (e.g., via some type of user interface, via one or more data or control signals received by the lighting unit, etc.). Alternatively, such identifiers may be determined at the time of initial use of the lighting unit in the field, and again may be alterable or non-alterable thereafter.

One issue that may arise in connection with controlling multiple light sources in the lighting unit 100 of FIG. 1, and controlling multiple lighting units 100 in a lighting system or lighting network (e.g., as discussed below in connection with FIG. 2), relates to potentially perceptible differences in light output between substantially similar light sources. For example, given two virtually identical light sources being driven by respective identical control signals, the actual intensity of light output by each light source may be perceptibly different. Such a difference in light output may be attributed to various factors including, for example, slight manufacturing differences between the light sources, normal wear and tear over time of the light sources that may differently alter the respective spectrums of the generated radiation, etc. For purposes of the present discussion, light sources for which a particular relationship between a control signal and resulting intensity are not known are referred to as “uncalibrated” light sources.

The use of one or more uncalibrated light sources in the lighting unit 100 shown in FIG. 1 may result in generation of light having an unpredictable, or “uncalibrated,” color or color temperature. For example, consider a first lighting unit including a first uncalibrated red light source and a first uncalibrated blue light source, each controlled by a corresponding control signal having an adjustable parameter in a range of from zero to 255 (0-255). For purposes of this example, if the red control signal is set to zero, blue light is generated, whereas if the blue control signal is set to zero, red light is generated. However, it both control signals are varied from non-zero values, a variety of perceptibly different colors may be produced (e.g., in this example, at very least, many different shades of purple are possible). In particular, perhaps a particular desired color (e.g., lavender) is given by a red control signal having a value of 125 and a blue control signal having a value of 200.

Now consider a second lighting unit including a second uncalibrated red light source substantially similar to the first uncalibrated red light source of the first lighting unit, and a second uncalibrated blue light source substantially similar to the first uncalibrated blue light source of the first lighting unit. As discussed above, even if both of the uncalibrated red light sources are driven by respective identical control signals, the actual intensity of light output by each red light source may be perceptibly different. Similarly, even if both of the uncalibrated blue light sources are driven by respective identical control signals, the actual intensity of light output by each blue light source may be perceptibly different.

With the foregoing in mind, it should be appreciated that if multiple uncalibrated light sources are used in combination in lighting units to produce a mixed colored light as discussed above, the observed color (or color temperature) of light produced by different lighting units under identical control conditions may be perceivably different. Specifically, consider again the “lavender” example above; the “first lavender” produced by the first lighting unit with a red control signal of 125 and a blue control signal of 200 indeed may be perceptibly different than a “second lavender” produced by the second lighting unit with a red control signal of 125 and a blue control signal of 200. More generally, the first and second lighting units generate uncalibrated colors by virtue of their uncalibrated light sources.

In view of the foregoing, in one embodiment of the present disclosure, the lighting unit 100 includes calibration means to facilitate the generation of light having a calibrated (e.g., predictable, reproducible) color at any given time. In one aspect, the calibration means is configured to adjust the light output of at least some light sources of the lighting unit so as to compensate for perceptible differences between similar light sources used in different lighting units.

For example, in one embodiment, the processor 102 of the lighting unit 100 is configured to control one or more of the light sources 104A, 104B, and 104C so as to output radiation at a calibrated intensity that substantially corresponds in a predetermined manner to a control signal for the light source(s). As a result of mixing radiation having different spectra and respective calibrated intensities, a calibrated color is produced. In one aspect of this embodiment, at least one calibration value for each light source is stored in the memory 114, and the processor is programmed to apply the respective calibration values to the control signals for the corresponding light sources so as to generate the calibrated intensities.

In one aspect of this embodiment, one or more calibration values may be determined once (e.g., during a lighting unit manufacturing/testing phase) and stored in the memory 114 for use by the processor 102. In another aspect, the processor 102 may be configured to derive one or more calibration values dynamically (e.g. from time to time) with the aid of one or more photosensors, for example. In various embodiments, the photosensor(s) may be one or more external components coupled to the lighting unit, or alternatively may be integrated as part of the lighting unit itself. A photosensor is one example of a signal source that may be integrated or otherwise associated with the lighting unit 100, and monitored by the processor 102 in connection with the operation of the lighting unit. Other examples of such signal sources are discussed further below, in connection with the signal source 124 shown in FIG. 1.

One exemplary method that may be implemented by the processor 102 to derive one or more calibration values includes applying a reference control signal to a light source, and measuring (e.g., via one or more photosensors) an intensity of radiation thus generated by the light source. The processor may be programmed to then make a comparison of the measured intensity and at least one reference value (e.g., representing an intensity that nominally would be expected in response to the reference control signal). Based on such a comparison, the processor may determine one or more calibration values for the light source. In particular, the processor may derive a calibration value such that, when applied to the reference control signal, the light source outputs radiation having an intensity the corresponds to the reference value (i.e., the “expected” intensity).

In various aspects, one calibration value may be derived for an entire range of control signal/output intensities for a given light source. Alternatively, multiple calibration values may be derived for a given light source (i.e., a number of calibration value “samples” may be obtained) that are respectively applied over different control signal/output intensity ranges, to approximate a nonlinear calibration function in a piecewise linear manner.

In another aspect, as also shown in FIG. 1, the lighting unit 100 optionally may include one or more user interfaces 118 that are provided to facilitate any of a number of user-selectable settings or functions (e.g., generally controlling the light output of the lighting unit 100, changing and/or selecting various pre-programmed lighting effects to be generated by the lighting unit, changing and/or selecting various parameters of selected lighting effects, setting particular identifiers such as addresses or serial numbers for the lighting unit, etc.). In various embodiments, the communication between the user interface 118 and the lighting unit may be accomplished through wire or cable, or wireless transmission.

In one implementation, the processor 102 of the lighting unit monitors the user interface 118 and controls one or more of the light sources 104A, 104B, and 104C based at least in part on a user's operation of the interface. For example, the processor 102 may be configured to respond to operation of the user interface by originating one or more control signals for controlling one or more of the light sources. Alternatively, the processor 102 may be configured to respond by selecting one or more pre-programmed control signals stored in memory, modifying control signals generated by executing a lighting program, selecting and executing a new lighting program from memory, or otherwise affecting the radiation generated by one or more of the light sources.

In particular, in one implementation, the user interface 118 may constitute one or more switches (e.g., a standard wall switch) that interrupt power to the processor 102. In one aspect of this implementation, the processor 102 is configured to monitor the power as controlled by the user interface, and in turn control one or more of the light sources 104A, 104B, and 104C based at least in part on a duration of a power interruption caused by operation of the user interface. As discussed above, the processor may be particularly configured to respond to a predetermined duration of a power interruption by, for example, selecting one or more pre-programmed control signals stored in memory, modifying control signals generated by executing a lighting program, selecting and executing a new lighting program from memory, or otherwise affecting the radiation generated by one or more of the light sources.

FIG. 1 also illustrates that the lighting unit 100 may be configured to receive one or more signals 122 from one or more other signal sources 124. In one implementation, the processor 102 of the lighting unit may use the signal(s) 122, either alone or in combination with other control signals (e.g., signals generated by executing a lighting program, one or more outputs from a user interface, etc.), so as to control one or more of the light sources 104A, 104B and 104C in a manner similar to that discussed above in connection with the user interface.

Examples of the signal(s) 122 that may be received and processed by the processor 102 include, but are not limited to, one or more audio signals, video signals, power signals, various types of data signals, signals representing information obtained from a network (e.g., the Internet), signals representing one or more detectable/sensed conditions, signals from lighting units, signals consisting of modulated light, etc. In various implementations, the signal source(s) 124 may be located remotely from the lighting unit 100, or included as a component of the lighting unit. For example, in one embodiment, a signal from one lighting unit 100 could be sent over a network to another lighting unit 100.

Some examples of a signal source 124 that may be employed in, or used in connection with, the lighting unit 100 of FIG. 1 include any of a variety of sensors or transducers that generate one or more signals 122 in response to some stimulus. Examples of such sensors include, but are not limited to, various types of environmental condition sensors, such as thermally sensitive (e.g., temperature, infrared) sensors, humidity sensors, motion sensors, photosensors/light sensors (e.g., sensors that are sensitive to one or more particular spectra of electromagnetic radiation), various types of cameras, sound or vibration sensors or other pressure/force transducers (e.g., microphones, piezoelectric devices), and the like.

Additional examples of a signal source 124 include various metering/detection devices that monitor electrical signals or characteristics (e.g., voltage, current, power, resistance, capacitance, inductance, etc.) or chemical/biological characteristics (e.g., acidity, a presence of one or more particular chemical or biological agents, bacteria, etc.) and provide one or more signals 122 based on measured values of the signals or characteristics. Yet other examples of a signal source 124 include various types of scanners, image recognition systems, voice or other sound recognition systems, artificial intelligence and robotics systems, and the like. A signal source 124 could also be a lighting unit 100, a processor 102, or any one of many available signal generating devices, such as media players, MP3 players, computers, DVD players, CD players, television signal sources, camera signal sources, microphones, speakers, telephones, cellular phones, instant messenger devices, SMS devices, wireless devices, personal organizer devices, and many others.

In one embodiment, the lighting unit 100 shown in FIG. 1 also may include one or more optical elements, referred to as an “optical facility” 130, to optically process the radiation generated by the light sources 104A, 104B, and 104C. For example, one or more optical elements may be configured so as to change one or both of a spatial distribution and a propagation direction of the generated radiation. In particular, one or more optical elements may be configured to change a diffusion angle of the generated radiation. In one aspect of this embodiment, one or more optical elements 130 may be particularly configured to variably change one or both of a spatial distribution and a propagation direction of the generated radiation (e.g., in response to some electrical and/or mechanical stimulus). Examples of optical elements that may be included in the lighting unit 100 include, but are not limited to, reflective materials, refractive materials, translucent materials, filters, lenses, mirrors, and fiber optics. The optical element 130 also may include a phosphorescent material, luminescent material, or other material capable of responding to or interacting with the generated radiation.

As also shown in FIG. 1, the lighting unit 100 may include one or more communication ports 120 to facilitate coupling of the lighting unit 100 to any of a variety of other devices. For example, one or more communication ports 120 may facilitate coupling multiple lighting units together as a lighting network, in which at least some of the lighting units are addressable (e.g., have particular identifiers or addresses) and are responsive to particular data transported across the network.

In particular, in a lighting network environment, as discussed in greater detail further below (e.g., in connection with FIG. 2), as data is communicated via the network, the processor 102 of each lighting unit coupled to the network may be configured to be responsive to particular data (e.g., lighting control commands) that pertain to it (e.g., in some cases, as dictated by the respective identifiers of the networked lighting units). Once a given processor identifies particular data intended for it, it may read the data and, for example, change the lighting conditions produced by its light sources according to the received data (e.g., by generating appropriate control signals to the light sources). In one aspect, the memory 114 of each lighting unit coupled to the network may be loaded, for example, with a table of lighting control signals that correspond with data the processor 102 receives. Once the processor 102 receives data from the network, the processor may consult the table to select the control signals that correspond to the received data, and control the light sources of the lighting unit accordingly.

In one aspect of this embodiment, the processor 102 of a given lighting unit, whether or not coupled to a network, may be configured to interpret lighting instructions/data that are received in a DMX protocol (as discussed, for example, in U.S. Pat. Nos. 6,016,038 and 6,211,626), which is a lighting command protocol conventionally employed in the lighting industry for some programmable lighting applications. However, it should be appreciated that lighting units suitable for purposes of the present disclosure are not limited in this respect, as lighting units according to various embodiments may be configured to be responsive to other types of communication protocols so as to control their respective light sources.

In one embodiment, the lighting unit 100 of FIG. 1 may include and/or be coupled to one or more power sources 108. In various aspects, examples of power source(s) 108 include, but are not limited to, AC power sources, DC power sources, batteries, solar-based power sources, thermoelectric or mechanical-based power sources and the like. Additionally, in one aspect, the power source(s) 108 may include or be associated with one or more power conversion devices that convert power received by an external power source to a form suitable for operation of the lighting unit 100.

While not shown explicitly in FIG. 1, the lighting unit 100 may be implemented in any one of several different structural configurations according to various embodiments of the present disclosure. Examples of such configurations include, but are not limited to, an essentially linear or curvilinear configuration, a circular configuration, an oval configuration, a rectangular configuration, combinations of the foregoing, various other geometrically shaped configurations, various two or three dimensional configurations, and the like.

A given lighting unit also may have any one of a variety of mounting arrangements for the light source(s), enclosure/housing arrangements and shapes to partially or fully enclose the light sources, and/or electrical and mechanical connection configurations. In particular, a lighting unit may be configured as a replacement or “retrofit” to engage electrically and mechanically in a conventional socket or fixture arrangement (e.g., an Edison-type screw socket, a halogen fixture arrangement, a fluorescent fixture arrangement, etc.).

Additionally, one or more optical elements as discussed above may be partially or fully integrated with an enclosure/housing arrangement for the lighting unit. Furthermore, a given lighting unit optionally may be associated with (e.g., include, be coupled to and/or packaged together with) various other components (e.g., control circuitry such as the processor and/or memory, one or more sensors/transducers/signal sources, user interfaces, displays, power sources, power conversion devices, etc.) relating to the operation of the light source(s).

FIG. 2 illustrates an example of a lighting network 200 according to one embodiment of the present disclosure. In the embodiment of FIG. 2, a number of lighting units 100, which may contain all or some subset of features discussed above in connection with FIG. 1, are coupled together to form the lighting network. It should be appreciated, however, that the particular configuration and arrangement of lighting units shown in FIG. 2 is for purposes of illustration only, and that the disclosure is not limited to the particular topology shown in FIG. 2.

As shown in the embodiment of FIG. 2, the lighting network 200 may include one or more lighting unit controllers (hereinafter “LUCs”) 208A, 208B, 208C, and 208D, wherein each LUC is responsible for communicating with and generally controlling one or more lighting units 100 coupled to it. Although FIG. 2 illustrates one lighting unit 100 coupled to each LUC, it should be appreciated that the disclosure is not limited in this respect, as different numbers of lighting units 100 may be coupled to a given LUC in a variety of different configurations (serially connections, parallel connections, combinations of serial and parallel connections, etc.) using a variety of different communication media and protocols.

In the network of FIG. 2, each LUC in turn may be coupled to a central controller 202 that is configured to communicate with one or more LUCs. Although FIG. 2 shows four LUCs coupled to the central controller 202 via a generic connection 204 (which may include any number of a variety of conventional coupling, switching and/or networking devices), it should be appreciated that according to various embodiments, different numbers of LUCs may be coupled to the central controller 202. Additionally, according to various embodiments of the present disclosure, the LUCs and the central controller may be coupled together in a variety of configurations using a variety of different communication media (wired or wireless) and protocols to form the lighting network 200. Moreover, it should be appreciated that the interconnection of lighting units to respective LUCs may be accomplished in different manners (e.g., using various configurations of serial or parallel connections, various communication media including wired or wireless media, and various communication protocols).

For example, according to one embodiment of the present disclosure, the central controller 202 shown in FIG. 2 may by configured to implement Ethernet-based communications with the LUCs, and in turn the LUCs may be configured to implement DMX-based communications with the lighting units 100. In particular, in one aspect of this embodiment, each LUC may be configured as an addressable Ethernet-based controller and accordingly may be identifiable to the central controller 202 via a particular unique address (or a unique group of addresses) using an Ethernet-based protocol. In this manner, the central controller 202 may be configured to support Ethernet communications throughout the network of coupled LUCs, and each LUC may respond to those communications intended for it. In turn, each LUC may communicate lighting control information to one or more lighting units coupled to it, for example, via a DMX protocol, based on the Ethernet communications with the central controller 202.

More specifically, according to one embodiment, the LUCs 208A, 208B, and 208C shown in FIG. 2 may be configured to be “intelligent” in that the central controller 202 may be configured to communicate higher level commands to the LUCs that need to be interpreted by the LUCs before lighting control information can be forwarded to the lighting units 100. For example, a lighting network operator may want to generate a color changing effect that varies colors from lighting unit to lighting unit in such a way as to generate the appearance of a propagating rainbow of colors (“rainbow chase”), given a particular placement of lighting units with respect to one another. In this example, the operator may provide a simple instruction to the central controller 202 to accomplish this, and in turn the central controller may communicate to one or more LUCs using an Ethernet-based protocol high level command to generate a “rainbow chase.” The command may contain timing, intensity, hue, saturation or other relevant information, for example. When a given LUC receives such a command, it may then interpret the command so as to generate the appropriate lighting control signals which it then communicates using a DMX protocol via any of a variety of signaling techniques (e.g., PWM) to one or more lighting units that it controls.

It should again be appreciated that the foregoing example of using multiple different communication implementations (e.g., Ethernet/DMX) in a lighting system according to one embodiment of the present disclosure is for purposes of illustration only, and that the disclosure is not limited to this particular example.

Additionally, while not shown explicitly in FIG. 2, it should be appreciated that the lighting network 200 may be configured flexibly to include one or more user interfaces, as well as one or more signal sources such as sensors/transducers. For example, one or more user interfaces and/or one or more signal sources such as sensors/transducers (as discussed above in connection with FIG. 1) may be associated with any one or more of the lighting units of the networked lighting system 200. Alternatively (or in addition to the foregoing), one or more user interfaces and/or one or more signal sources may be implemented as “stand alone” components in the lighting network 200. In various aspects, one or more user interfaces may be configured to control one or more lighting functions of all or a portion of the lighting network 200 via the central controller 202 and/or via one or more of the lighting units 100. Whether stand alone components or particularly associated with one or more lighting units 100, one or more user interfaces or signal sources may be “shared” by the lighting units of the lighting network. Stated differently, one or more user interfaces and/or one or more signal sources such as sensors/transducers may constitute “shared resources” in the lighting network that may be used in connection with controlling any one or more of the lighting units of the network.

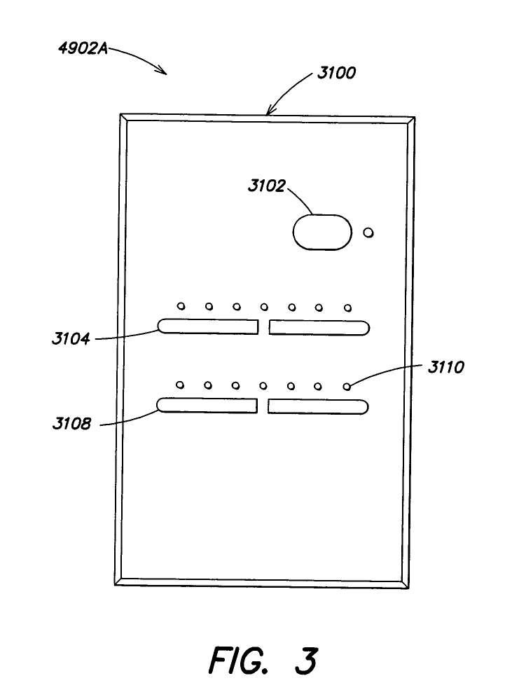

FIG. 3 illustrates a user interface 4902A according to one embodiment of the present disclosure, which may be configured to control one or multiple lighting units 100. In one aspect, the user interface 4902A may include a touchpad 3100 having one or more selection mechanisms, such as buttons, dials, sliders, toggles, switches or the like, for selecting or changing a desired parameter. For purposes of the present discussion, the term “button” is used generally for convenience to refer to any one of a number of possible selection mechanisms for allowing a user to change a desired parameter.

As shown in FIG. 3, in one embodiment, the touchpad 3100 may include a power button 3102, one or more dimmer buttons 3104, one or more color temperature control buttons 3108 and one or more indicators 3110 (e.g., indicator LEDs). Specifically, in one exemplary implementation as shown in FIG. 3, a first pair of side-by-side dimmer buttons 3104 (a left dimmer button and a right dimmer button) are provided with a first row of indicator LEDs provided just above the first pair of buttons. Similarly, a second pair of side-by-side color temperature buttons 3108 (a left color temperature button and a right color temperature button) are provided, with a second row of indicator LEDs provided just above the second pair of buttons.

In one aspect of the user interface shown in FIG. 3, the number of indicator LEDs turned on moving from left to right along a given row provides a relative indication to the user of degree associated with a given parameter. For example, as a given parameter is increased, a greater number of indicator LEDs is turned on moving from left to right along a given row. In another aspect, if a user wishes to increase one or both of perceivable brightness and color temperature of generated light, they would depress the right button of the corresponding pair of buttons, and the row of indicator LEDs above the button pair would indicate a relative amount of the increase. In contrast, if the user wishes to decrease one or both of perceivable brightness and color temperature of the generated light, they would depress the left button of the corresponding pair of buttons and the row of indicator LEDs above the button pair would indicate a relative amount of the decrease.

Thus, the user interface of FIG. 3 is configured such that the dimmer buttons 3104 allow a user to change the overall intensity of light generated by one or more lighting units 100, and the color temperature buttons 3108 allow the user to vary the color temperature of the light generated from one or more lighting units (e.g., so as to provide a “warm” or “cool” white light). In yet another aspect, the user interface 4902A is configured such that user input provided via the buttons 3104 and 3108 is converted into one or more lighting control signals that are employed to ultimately control one or more lighting units via any one of a number of possible communication links and protocols, some examples of which are discussed above in connection with FIG. 2.

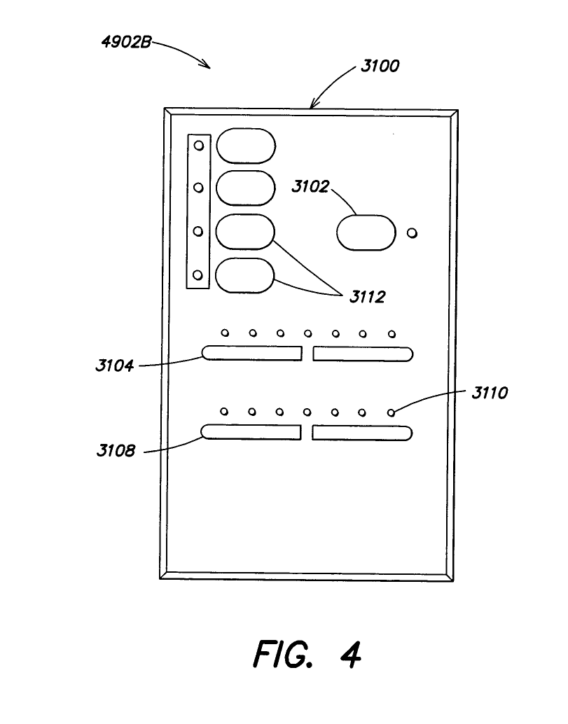

FIG. 4 illustrates a user interface 4902B according to another embodiment of the present disclosure. As shown in FIG. 4, in addition to the power button 3102, dimmer button(s) 3104, and color temperature button(s) 3108, the touchpad 3100 can include one or more program trigger buttons 3112 (which, like the buttons 3102, 3104, 3108, can be buttons, dials, sliders, toggles, switches, or the like). The program trigger buttons 3112 can be used to trigger one or more lighting programs that, when executed, define one or more static or dynamic states or particular lighting conditions for one or more lighting units. As shown in FIG. 4, each trigger button 3112 may be associated with a corresponding indicator LED to indicate selection of the trigger button.

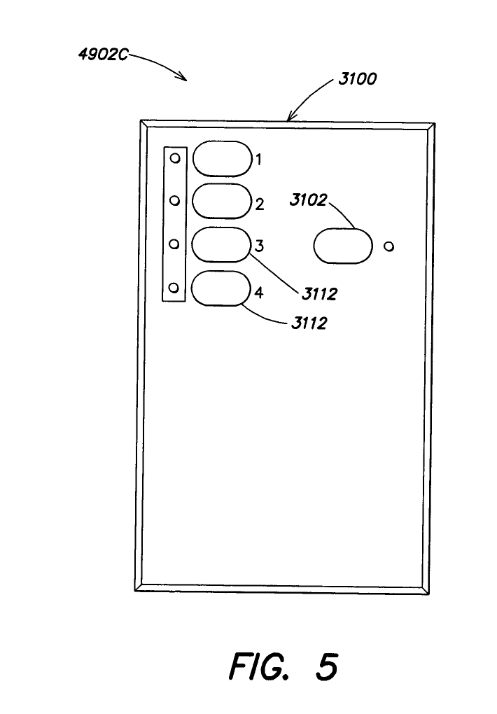

FIG. 5 illustrates a user interface 4902C according to another embodiment, in which the touchpad 3100 includes only a power button 3102 and one or more program trigger buttons 3112. For some lighting applications, it may be desirable to omit other control possibilities via the user interface (e.g., specific intensity control or color temperature control), such that a user has only some prescribed control options from which to select. For example, a lighting designer or facilities manager for a given environment (e.g., an exterior or interior architectural space such as a home, office or work environment, franchised store, museum, restaurant, casino, theatre, sporting facility, etc.) may wish to offer only specific predetermined lighting conditions without allowing for a more arbitrary range of control. Hence, the user interface of FIG. 5 may be appropriate in such applications to allow selection only amongst some number of predetermined lighting conditions via the program trigger buttons 3112.

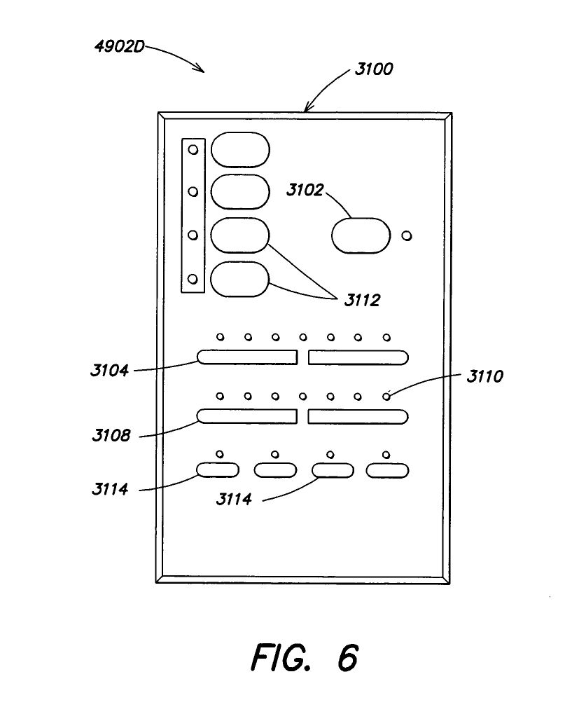

FIG. 6 illustrates yet another embodiment of a user interface 4902D according to the present disclosure particularly configured for control of a lighting network including multiple lighting units. In one exemplary lighting network according to the present disclosure, the network is configured such that control of the network may be specified in terms of particular lighting “zones.” For example, different areas of an environment in which light is provided by the lighting network may be divided into respective lighting zones, and some or all of the lighting units of the lighting network may be configured so as to provide controllable lighting in one or more such lighting zones on a zone-by-zone basis. To this end, in addition to program trigger buttons 3112, a power button 3102, color temperature button(s) 3108 and dimmer/intensity button(s) 3104, the touchpad 3100 of the user interface 4902D shown in FIG. 6 includes one or more zone select buttons 3114.

Specifically, the zone select button(s) 3114 shown in FIG. 6 allow the user to specifically control lighting conditions in one or more lighting zones of a multi-zone environment on a zone-by-zone basis. In one exemplary implementation, the user interface of FIG. 6 may be coupled to the central controller 202 of the lighting network 200 shown in FIG. 2, and the central controller may be configured to respond to signals generated by the user interface and in turn generate control signals to one or more lighting unit controllers (LUCs) based on a predetermined assignment of one or more LUCs to one or more corresponding lighting zones. For example, with reference to FIG. 2, the network may be configured such that the LUC 208A is assigned to a first lighting zone, the LUCs 208B and 208C are assigned to a second lighting zone, and the LUC 208D is assigned to a third lighting zone. Accordingly, in this example, all of the lighting units coupled to the LUCs 208B and 208C may be controlled similarly as a single lighting zone via the user interface. It should be appreciated that the foregoing example is provided primarily for purposes of illustration, and that any number of LUCs may be assigned to a given lighting zone, such that a given lighting zone may have an arbitrary number of lighting units associated with the zone. Additionally, there is no particular limit to the number of zones into which a given lighting network deployed in a particular environment is divided.

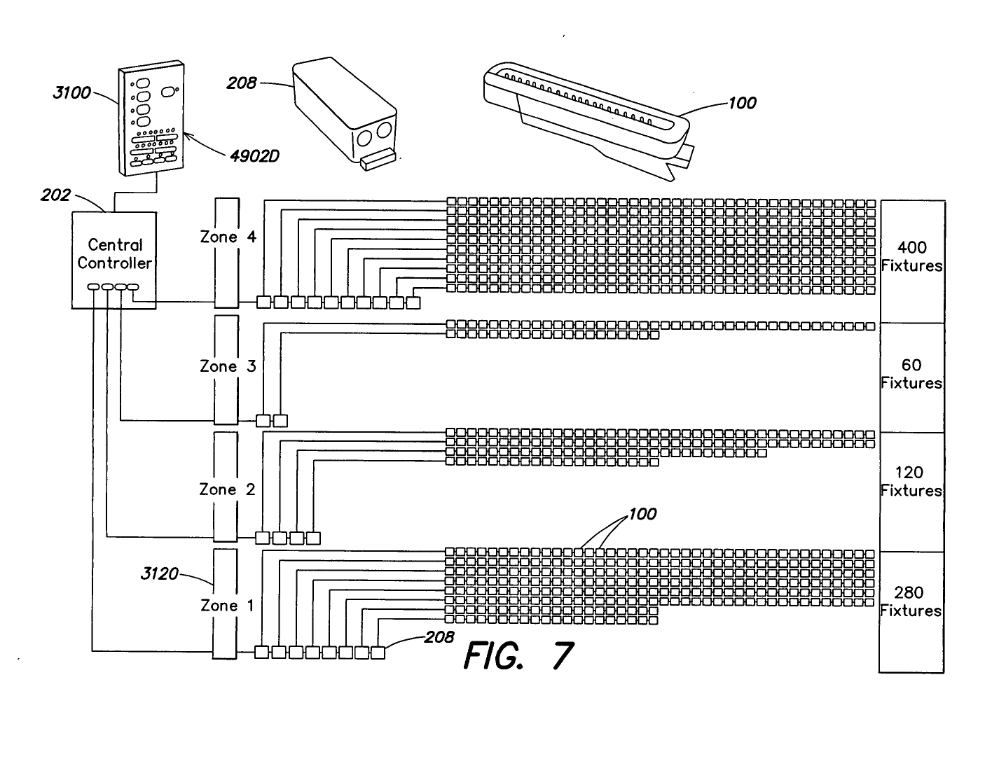

FIG. 7 illustrates a somewhat more complex configuration of a lighting network similar to the network shown in FIG. 2, in which a plurality of LUCs 208 are divided up into four different zones 3120. The LUCs 208, as well as the user interface 4902D discussed above in connection with FIG. 6, are coupled to the central controller 202. Based on the configuration of four zones, the touchpad 3100 of the user interface 4902D includes at least four zone control buttons, each such button corresponding to one of the four zones 3120. From FIG. 7, it may be readily appreciated that a significant number of lighting units 100 may be controlled by any number of LUCs assigned to a given zone; accordingly, in the network of FIG. 7, a significant number of lighting units 100 essentially can be controlled identically and simultaneously via a single zone selection button of the touchpad 3100.

More specifically, with reference again to FIG. 6, via the user interface 4902D a user may first select a desired zone in the network of FIG. 7 via a zone select button 3114, followed by a selection of one or more of the dimming buttons 3104, the color temperature buttons 3108, and the trigger buttons 3112. For example, the user may wish to change the intensity of all of the lights in zone 3; accordingly, the user first selects the zone select button corresponding to zone 3, followed by one of the left or right buttons of the pair of dimming buttons. Likewise, if a particular zone is equipped with lighting units configured to provide controllable white light, the user may select that zone via the corresponding zone select button, followed by one of the left or right button of the pair of color temperature buttons to adjust the white light in the selected zone between warmer white color temperatures (relative lower color temperatures) and cooler white color temperatures (relatively higher color temperatures). If the user wishes to have a particular lighting program or effect applied to a given zone, the user first selects the appropriate zone control button, followed by one of the trigger buttons corresponding to the desired lighting program or effect.

Thus, a significant degree of control over a complex lighting environment is afforded in a relatively simple and intuitive manner by user interfaces similar to those discussed above in connection with FIGS. 3-6, and especially in complex lighting installations involving multiple lighting zones. For example, lighting conditions in an office or work environment outfitted with a multiple-zone lighting network and one or more user interfaces according to various embodiments disclosed herein may be easily adjusted and tailored based on different rooms, departments, hallways or the like. Likewise, lighting conditions in a retail environment similarly outfitted may be easily adjusted and tailored based on type and/or location of items for purchase as well as advertising displays (e.g., the lighting network can be controlled to provide different lighting conditions associated with different shelves, displays, storefronts, hallways, checkout counters, dressing rooms, etc). Different rooms, or different parts of a room, of a home equipped with a multiple-zone lighting network according to the present disclosure similarly may be controlled.

As discussed above, lighting conditions in any one of the aforementioned exemplary environments, as well as other environments, may be easily controlled on a zone-by-zone basis according to one or more predetermined lighting programs or effects via one or more trigger buttons of the user interface. For example, a given environment could have preset lighting conditions established for morning, afternoon and evening, each implemented by a corresponding lighting program executed in response to the selection of a given trigger button. Similarly, a home could have preset lighting conditions established for dining, watching television, playing games, or doing homework, each selectable via a corresponding trigger button. Lighting programs selectable via a trigger button also may implement lighting conditions to indicate an alarm or emergency situation in one or more zones (e.g., rapidly flashing lights), as well as any of a variety of dynamic lighting effects (e.g., gradual fades or increases in intensity over time, varying color temperature over time, variable color over time, etc.).

In the lighting networks shown in FIGS. 2 and 7, it should be appreciated that according to one embodiment, lighting zones may be established based on a particular type of lighting unit to be deployed in a given zone. For example, a first zone may be established to control one or more lighting units configured to generate fixed color temperature white light, a second zone may be established to control one or more lighting units configured to generate variable color temperature white light, a third zone may be established to control one or more lighting units configured to generate variable color light, a fourth zone may be established to control one or more lighting units configured as relatively low intensity accent lighting, and a fifth zone may be established to control one or more lighting units configured to provide emergency lighting. Similarly, multiple lighting zones may be established in which the lighting condition in each zone is based primarily on white light, but again different types of lighting units are employed in different zones to generate different types of essentially white light (e.g., relatively high intensity, relatively low intensity, particular color temperature ranges, different beam sizes or spatial distribution of light, focused light, diffuse light, etc.).

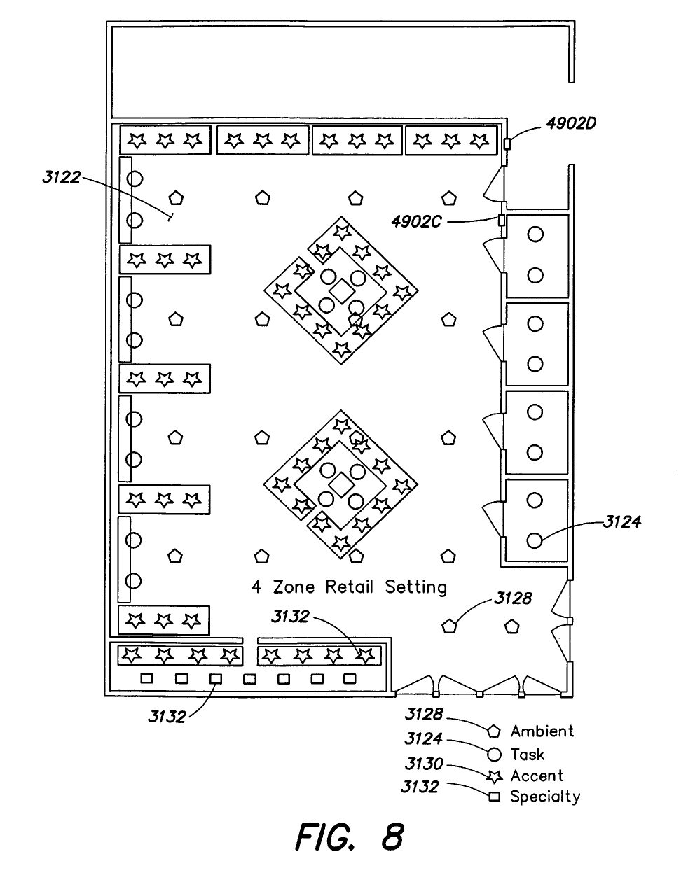

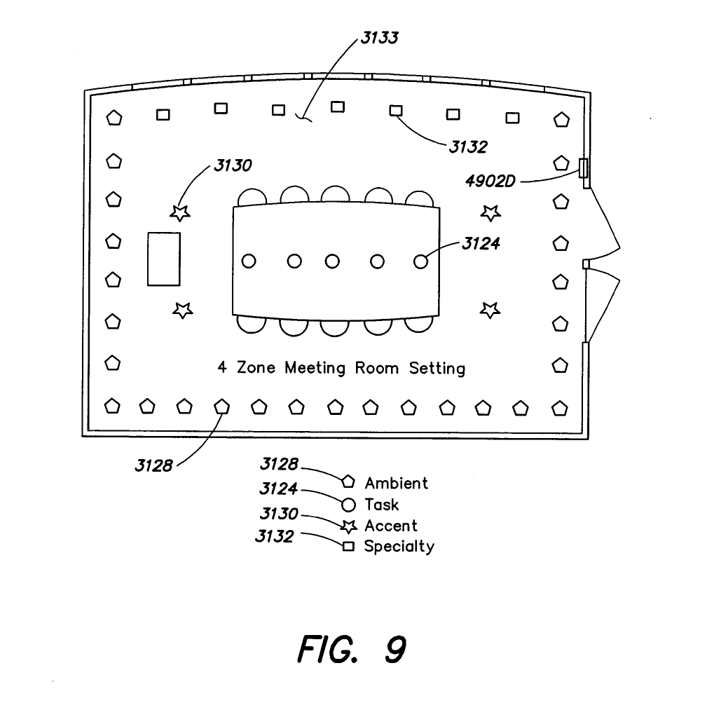

FIGS. 8-10 are diagrams of a retail environment 3122, an office environment 3133, and a home environment 3134, respectively, in which a multiple-zone lighting network is employed, according to various embodiments of the present disclosure. In the environments depicted in FIGS. 8-10, the exemplary lighting networks are arranged as four zone networks, in which each zone is associated with a particular type of lighting unit. In particular, in the lighting networks of FIGS. 8-10, a first zone is associated with “ambient” lighting units 3128 (indicated in the figures as pentagons; e.g., to provide diffuse ambient illumination), a second zone is associated with “task” lighting units 3124 (indicated in the figures as circles; e.g., to provide focused lighting on a particular area or object), a third zone is associated with “accent” lighting units 3130 (indicated in the figures as stars; e.g., to provide decorative lighting to highlight or outline specific architectural features, such as coves, shelving, entrance ways, room or building perimeters, etc.), and a fourth zone is associated with “specialty” lighting units 3132 (indicated in the figures as squares; e.g., to provide specialized distributions of light patterns and/or multicolor light). It should be appreciated that the environments depicted in FIGS. 8-10 are not limited to the particular lighting network configurations shown in the figures, but that these figures merely represent examples of possible lighting network implementations according to the present disclosure. Likewise, it should be appreciated that the particular lighting type and zone relationship discussed above merely represents one example of possible multiple-zone lighting arrangements according to the present disclosure.

In the lighting networks of FIGS. 8-10, one or more user interfaces, including different types of user interfaces as discussed above in connection with FIGS. 3-6, may be employed to control lighting conditions in one or more zones. For example, in one embodiment, the lighting network may be equipped with a “master controller” user interface, similar to the user interface 4902D discussed above in connection with FIG. 6. In this embodiment, the master controller user interface allows lighting control in any one or more of the four zones based on light intensity or color temperature variations, as well as one or more selectable lighting programs. In another embodiment, one or more zones may be equipped with a “dedicated zone controller” user interface, which allows adjustment of light intensity and/or color temperature, and/or selection of one or more predetermined lighting programs in a particular zone (similar to the user interfaces 4902A or 4902B shown in FIGS. 3 and 4).

In another embodiment, one or more zones may be equipped with a “dedicated trigger controller” user interface, which only allows the selection of one or more predetermined lighting programs, representing a particular lighting condition or effect, in a given zone (similar to the user interface 4902C shown in FIG. 5). In yet another embodiment, a “master trigger controller” user interface may be employed for multiple zones, in which one or more predetermined lighting programs may be selected to determine lighting conditions and/or effects in multiple zones or all of the zones of the lighting network. In this manner, with the single selection of a trigger button on the master trigger controller user interface, predetermined lighting conditions may be established in multiple or all four zones, including preset color temperatures and/or intensities for one or more of the zones.

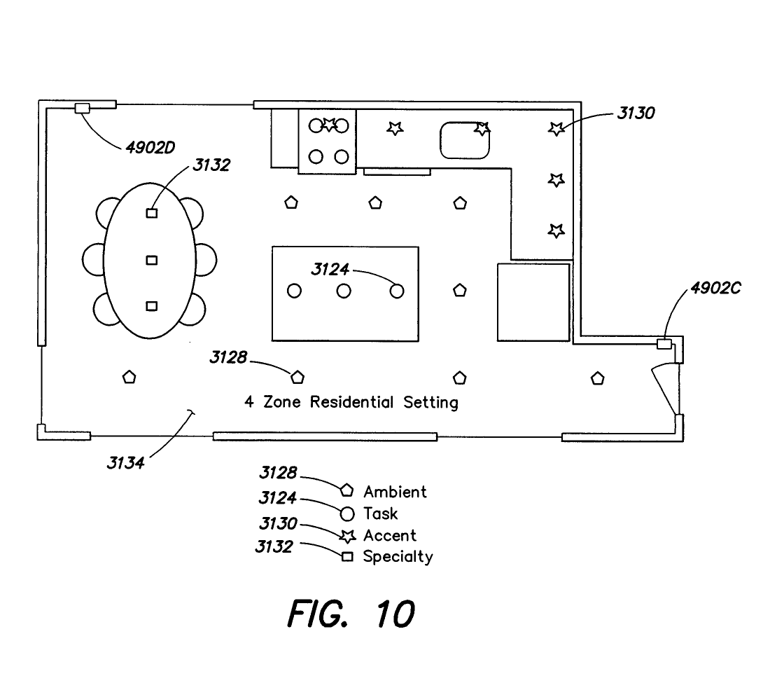

In yet another embodiment, one or more master controller user interfaces may be employed in combination with one or more dedicated zone controllers, dedicated trigger controllers, or master trigger controllers in a given lighting network implementation similar to those shown in FIGS. 8-10. For example, a master controller user interface 4902D may be used by a manager or facilities operator to control the ambient lights 3128, the task lights 3124, the accent lights 3130 and the specialty lights 3132 disposed throughout a given environment, using presets (predetermined lighting programs) or on-the-fly adjustments of intensity or color temperature. For one or more particular zones, a dedicated controller may be employed to provide a more limited range of lighting control (e.g., just controlling the specialty lights 3132 in a retail environment). Alternatively, as shown in the home environment illustrated in FIG. 10, a master trigger controller 4902C may be disposed near an entrance to a room, and provide for one-touch quick access to predetermined programmed lighting conditions for multiple or all of the zones in the room.

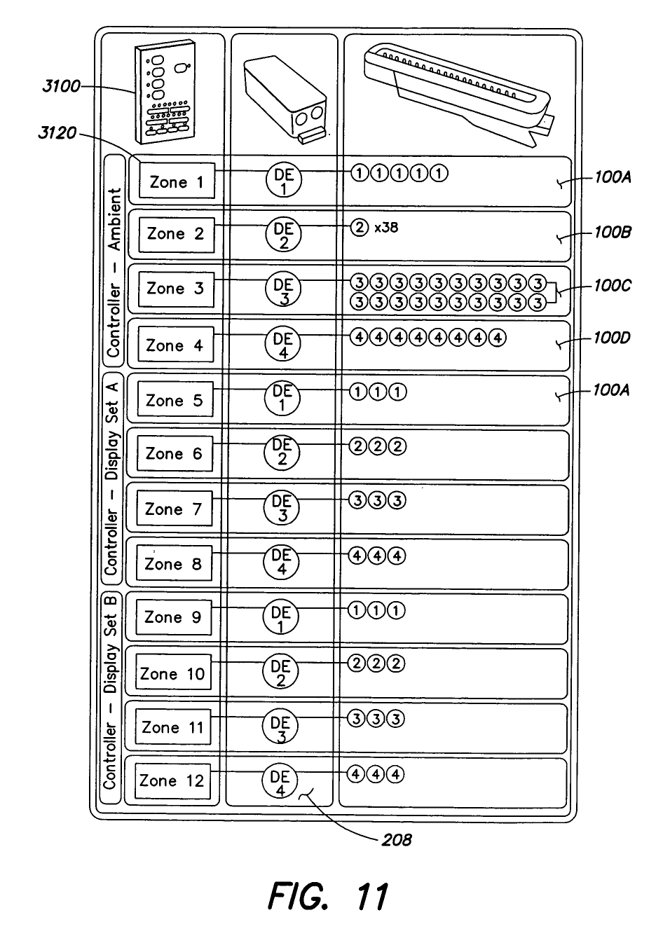

FIG. 11 is a diagram similar to FIG. 7, showing another multiple-zone configuration of a lighting network, according to one embodiment of the present disclosure. In FIG. 11, twelve zones 3120 are identified, each zone associated with a corresponding LUC 208. The LUC in each zone is coupled to one or more of a particular type of lighting unit 100. For example, in zone 1 of FIG. 11, the LUC is coupled to five lighting units 100A of a first type. In zone 2, the LUC is coupled to one lighting unit 100B of a second type. In zone 3, the LUC is coupled to 20 lighting units 100C of a third type. In zone 4, the LUC is coupled to eight lighting units 100D of a fourth type. In the configuration represented by the diagram of FIG. 11, each of the twelve zones does not necessarily have to represent a unique type of lighting unit; for example, in zone 5, the LUC is coupled to three lighting units 100A of the first type (also used in zone 1), and in zone 6 the LUC is coupled to three lighting units of the second type (also used in zone 2).

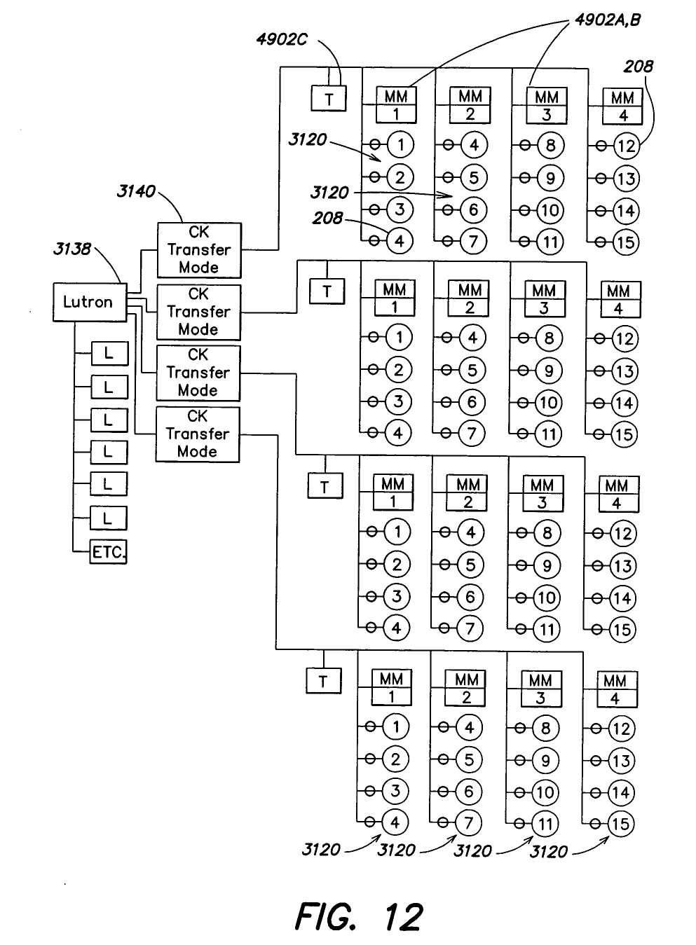

FIG. 12 shows yet another somewhat complex lighting network configuration employing multiple user interfaces, similar to those discussed above in connection with FIGS. 3-6, according to another embodiment of the present disclosure. For example, in FIG. 23, multiple trigger controllers 4902C are employed to allow selection of one or more lighting programs or effects common to multiple zones 3120. Additionally, each zone 3120 may include multiple LUCs 208 and a dedicated zone controller 4902A or 4902B to control one or more of intensity, color temperature, and lighting programs for a given zone. The network configuration of FIG. 12 also may include one or more transfer boxes 3140 for converting control signals from a master lighting controller, such as Lutron lighting controller 3138, into control signals for LED-based lighting units 100 couple to the LUCs 208. In various aspects, the transfer boxes 3140 may be configured to convert control signals and/or provide other intelligence or programming, such as allowing time-based effects, preset effects, or the like.

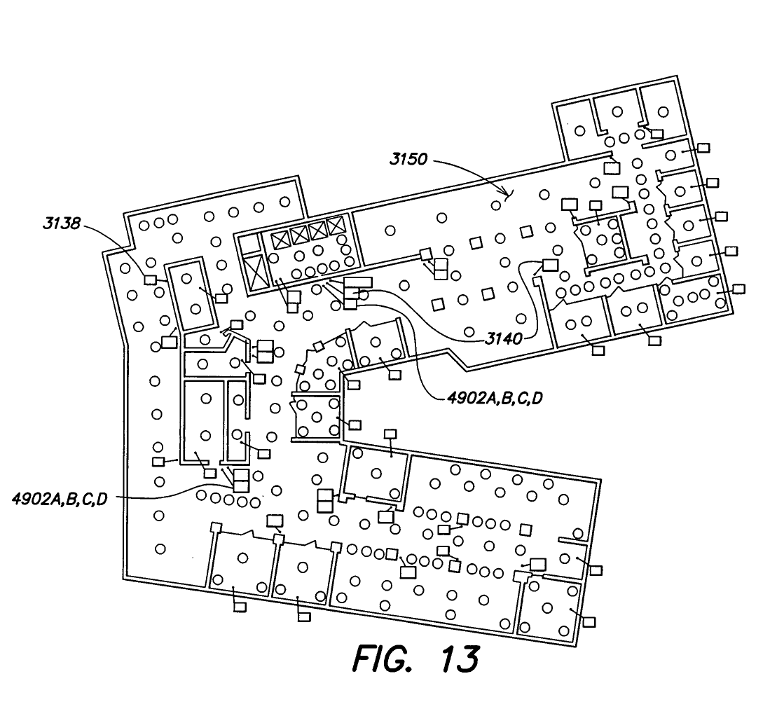

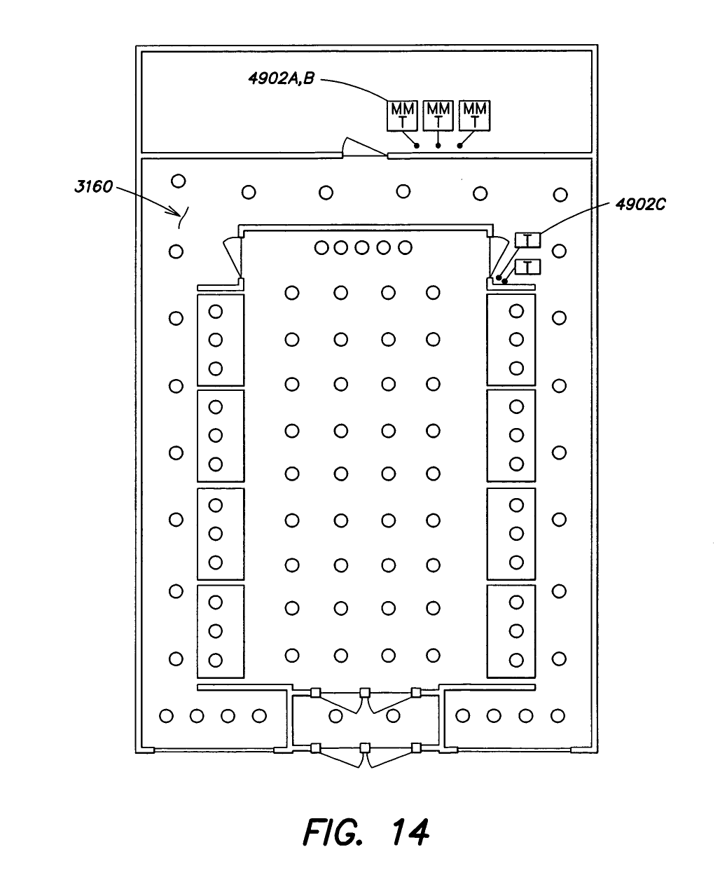

FIGS. 13 and 14 show a large building environment 3150 and a large retail environment 3160, respectively, in which a lighting network similar to that shown in FIG. 12 may be deployed. Controllers such as the Lutron controllers 3138, one or more dedicated zone controller user interfaces 4902A or 4902B, one or more master controllers 4902D, and one or more dedicated or master triggering controllers 4902C may be disposed at one or more locations in either environment to facilitate control of the lighting network.

In yet another embodiment, one or more sensors, such as photosensors or light detectors, may by placed in one or more zones of a multiple-zone lighting network and coupled to the network, to measure lighting conditions in the one or more zones due to natural sources (e.g., outdoor light entering through windows or doors), light provided by one or more lighting units of the lighting network, or both. Based on the measured lighting conditions, the light provided in one or more zones by the lighting network may be adjusted in a variety of manners. For example, in a given space with windows and multiple lighting zones, the lighting conditions in one or more zones can be measured and controlled such that lighting zones located more closely to the window provide a relatively lower light intensity (supplemented by the natural light), while lighting zones located at a greater distance from the windows provide a higher light intensity (where there is less natural light). Similarly, color temperature in one or more zones may be adjusted such that the color temperature of the natural light entering through the windows may be approximated or replicated in one or more zones located at a greater distance from the window.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. An apparatus, comprising:
at least one user interface to facilitate control of a lighting network including multiple LED-based lighting units configured to provide light in a plurality of lighting zones, wherein at least a first light is provided in a first zone of the plurality of lighting zones, the first light being perceived as essentially white light, the user interface comprising:
at least one first mechanism to facilitate a selection of a first color temperature of the first light generated in the first lighting zone.

2. The apparatus of claim 1, wherein the at least one first mechanism includes at least one trigger mechanism configured to select at least one lighting program which, when executed, provides the first color temperature of the first light generated in the first lighting zone.

3. The apparatus of claim 2, wherein the at least one trigger mechanism is configured to select at least one lighting program which, when executed, provides the first color temperature of the first light generated in the first lighting zone and at least one second lighting condition of second light provided in at least one other zone of the plurality of zones.

4. The apparatus of claim 3, wherein the second light is perceived as essentially white light, and wherein the lighting program, when executed, provides a second color temperature of the second light.

5. The apparatus of claim 3, wherein the second light is perceived as colored light, and wherein the lighting program, when executed, provides a color of the second light.

6. The apparatus of claim 3, wherein the second light is perceived as colored light or essentially white light, and wherein the lighting program, when executed, provides a particular intensity of the second light.

7. The apparatus of claim 1, wherein the at least one first mechanism is configured to facilitate a variation of the first color temperature of the first light.

8. The apparatus of claim 1, wherein the at least one user interface further comprises at least one second mechanism to facilitate a selection of at least the first lighting zone.

9. The apparatus of claim 8, wherein the at least one user interface further comprises at least one third mechanism to facilitate a selection of a first intensity of the first light generated in the first lighting zone.

10. The apparatus of claim 9, wherein the at least one third mechanism is configured to facilitate a variation of the first intensity of the first light.

11. The apparatus of claim 9, wherein the at least one second mechanism includes a plurality of second mechanisms to facilitate a selection of any one of the plurality of lighting zones.

12. The apparatus of any of claims 1, 2 or 11, further comprising the lighting network.

13. The apparatus of claim 12, wherein at least a second light is provided in a second zone of the plurality of lighting zones, the second light being perceived as essentially white light, and wherein the at least one user interface is configured to facilitate the selection of the first color temperature of the first light and a selection of a second color temperature of the second light.

14. The apparatus of claim 13, wherein the first color temperature and the second color temperature are different.

15. A method of controlling a lighting network including multiple LED-based lighting units configured to provide light in a plurality of lighting zones, wherein at least a first light is provided in a first zone of the plurality of lighting zones, the first light being perceived as essentially white light, the method comprising:
selecting a fist color temperature of the first light.

16. The method of claim 15, further comprising:
selecting a first intensity of the first light.

17. The method of claim 15, further comprising:
selecting at least one lighting program that, when executed, provides the first color temperature of the first light.

18. The method of claim 15, wherein at least a second light is provided in a second zone of the plurality of lighting zones, the second light being perceived as essentially white light, and wherein the method further comprises:
selecting a second color temperature of the second light.

19. The method of claim 18, wherein the first color temperature and the second color temperature are different.

20. A lighting network, comprising:
a plurality of LED-based lighting units configured to provide light in a plurality of lighting zones, wherein at least a first light is provided in a first zone of the plurality of lighting zones, the first light being perceived as essentially white light, and wherein a second light is provided in a second zone of the plurality of lighting zones, the second light being perceived as essentially white light; and
at least one user interface configured to facilitate a selection or adjustment of a first color temperature of the first light and a second color temperature of the second light.
